(19) United States
(12) Patent Application Publication
(10) Pub. No.: US 2024/0038434 A1
(43) Pub. Date: Feb. 1, 2024

(54) MAGNETIC CORE WITH PROTECTIVE HOUSING

(71) Applicant: Vacuumschmelze GmbH & Co. KG, Hanau (DE)

(72) Inventors: Axel Schulze, Hanau (DE); Harald Hundt, Hanau (DE); Johannes Binkofski, Hanau (DE); Alfred Auer, Hanau (DE); Christian Polak, Hanau (DE)

(21) Appl. No.: 18/227,164

(22) Filed: Jul. 27, 2023

(30) Foreign Application Priority Data
Jul. 29, 2022 (DE) 102022119155.9

(51) Int. Cl. H01F 27/26; H01F 3/04; H01F 27/02; H01F 41/02; H01F 1/153

(52) U.S. Cl. CPC H01F 27/266; H01F 3/04; H01F 27/02; H01F 41/0213; H01F 1/15333; H01F 1/15391; H01F 1/15308

(57) ABSTRACT

A device is described, which, according to one exemplary embodiment, includes a carrier which has a through opening along a longitudinal axis, and at least one soft magnetic strip wound around the carrier to form a toroidal strip core. The strip is wound directly onto the carrier so that there is no play between the toroidal strip core and the carrier. The carrier can thus serve as part of the housing of the toroidal strip core.

### TECHNICAL FIELD

The present description relates to the field of magnetic cores, inductive components and current transformers.

### BACKGROUND

For the manufacture of inductive components such as transformers, chokes, current transformers, etc., cores made of crystalline iron-based alloys such as silicon-iron, often also amorphous and nanocrystalline alloys are used. Selection criteria for the material of the magnetic core are high permeability, low coercivity (H_{c}), low losses and high linearity of the hysteresis loop.

In the development of magnetic cores made of amorphous and nanocrystalline alloys, it has been shown that a heat treatment in the range of 300 to 600° C. is often required after core production (by winding the magnetic strip material) in order to achieve the desired magnetic properties. For this purpose, heat treatment of the wound cores in an oven has become established. After the heat treatment, the mechanically sensitive cores need to be protected, for example by a coating or a housing. This sequence (heat treatment after initial core winding) precludes the possibility of winding the strip material directly onto a plastic material body since the plastic material would not survive the heat treatment. The usual technical plastics have a temperature resistance of about 120 to 200° C., the heat treatment usually takes place above 400° C.

Methods for manufacturing magnetic cores are known, according to which an amorphous strip is heat-treated under tension and passed through a furnace in order to produce a nanocrystalline strip material, from which a magnetic core (toroidal strip core, also referred to as wound ring core or tape wound ring core) is then wound. The magnetic properties of the nanocrystalline strip can be adjusted, among other things, by controlling the tensile stress. Such strip material is sometimes referred to as zina material (zina=tensile stress-induced anisotropy).

Such magnetic strip material already has the desired magnetic properties, so that heat treatment is no longer necessary after winding into a magnetic core, but the strip loses its ductility during heat treatment and becomes relatively brittle. Brittle strip material can cause problems in the manufacture of magnetic cores because it breaks easily.

The inventors identified the need for the improvement of existing concepts for the production of wound magnetic cores arranged in a housing, so that in particular comparatively brittle materials can also be processed.

### SUMMARY

A device is described in the following, which, according to an exemplary embodiment, has a carrier which has a through opening along a longitudinal axis, and at least one soft magnetic strip wound around the carrier to form a toroidal strip core. In particular, the strip is wound directly onto the carrier so that there is no play between the toroidal strip core and the carrier. The carrier can thus serve as part of the housing of the toroidal strip core.

Furthermore, a method for producing a toroidal strip core is described. According to one exemplary embodiment, the method comprises fitting a carrier (or a part thereof), which has a through opening along a longitudinal axis, onto a shaft; winding at least one soft magnetic strip around the carrier to form at least one toroidal strip core by rotating the shaft; and removing the carrier and toroidal strip core from the shaft.

According to a further exemplary embodiment, the method comprises fitting a first part of a carrier, which has a through opening along a longitudinal axis, onto a shaft; winding a first soft magnetic strip around the first part of the carrier into a first toroidal strip core by rotating the shaft; removing the first part of the carrier including the first toroidal strip core from the shaft; fitting a second part of a carrier; winding a second soft magnetic strip around the second part of the carrier into a second toroidal strip core by rotating the shaft; removing the second part of the carrier including the second toroidal strip core from the shaft; and assembling the first and second parts of the carrier and the toroidal strip cores wound thereon, wherein the first and second part of the carrier are coaxial with one another.

### BRIEF DESCRIPTION OF THE DRAWINGS

Exemplary embodiments are explained in more detail below with the aid of illustrations. The illustrations are not necessarily to scale and the exemplary embodiments are not limited only to the aspects illustrated. Rather, emphasis is placed on presenting the principles on which the exemplary embodiments are based. In particular, in the figures:

FIG. 1 illustrates a first exemplary embodiment of a wound core with a housing;

FIG. 2 shows a modification of the example from FIG. 1 as a second exemplary embodiment;

FIG. 3 illustrates a third exemplary embodiment of a wound core with a housing;

FIG. 4 illustrates a fourth exemplary embodiment of a wound core with a housing, wherein two housing parts are held together by means of a snap-in connection;

FIG. 5 shows a modification of the example from FIG. 3 as a fifth exemplary embodiment;

FIG. 6 shows an inductive component with a core according to FIG. 4 and a coil wound around it;

FIG. 7 shows a cross-sectional representation through a wound magnetic core, the end of which protrudes due to the spring action of the strip and prevents the strip from unwinding through the housing; and

FIG. 8 shows a carrier on a winding shaft in a view in the axial direction.

### DETAILED DESCRIPTION

The presently described exemplary embodiments make it possible to produce a wound core from a soft magnetic strip after the strip has been heat-treated and thus has its final magnetic properties. The strip is then wound directly onto a carrier. After the core has been manufactured by winding the strip, the core remains on the carrier, which at the same time forms part of the housing of the magnetic core. The housing is completed by at least one second housing part (outer shell) that is slid or pushed over the magnetic core. The carrier and the outer shell are designed in such a way that they form a closed housing for the magnetic core located on the carrier. In this case, the housing can occupy a smaller volume than a housing in which a core that has been heat-treated after winding is inserted, since the necessary assembly gaps are eliminated. Furthermore, the assembly of the core is simplified and, as a result, an economical manufacturing process at lower costs is made possible.

Assembly is particularly economical when the outer shell (housing part) is dimensioned so small that it is not necessary to fasten the end of the wound strip. The coming off of the outer layer of the wound core is so slight that it does not result in any significant change in its magnetic properties. The concept described for producing a magnetic core is particularly suitable for strips made of comparatively brittle magnetic material (such as nanocrystalline strips which are heat-treated under tensile stress in a continuous furnace). Since the carrier onto which the strip is wound also forms part of the core housing, there is no need to pull the wound core off a winding shaft, which could easily break the brittle strip. The concepts described here also make handling the wound core safer and easier in the further production steps (also before closing the housing).

Depending on the application, the arrangement of the magnetic core in a closed housing can be an essential prerequisite for further processing, such as for winding a conductor around the core (to produce a coil). The electrical insulation can also play a role, since the metallic magnetic core represents a shortening of the clearance and creepage distance between two windings arranged on the core. If, according to the presently described exemplary embodiments, the magnetic core is wound directly onto a carrier, which then forms part of the housing of the core, the otherwise necessary assembly gaps are eliminated (namely there is no play between the toroidal strip core and the carrier), as mentioned, which is why more magnet volume is possible with the same installation space as with conventional concepts. If insulation is not required in an application, the outer shell of the housing can be omitted and the carrier on which the magnetic core is wound forms an open housing.

The soft magnetic strip can be made of an iron alloy or a cobalt alloy. In some exemplary embodiments, the strip consists of an iron alloy, which is described by the formula Fe_{100-a-b-c-x-y-z}CuₐNb_{b}M_{c}T_{d}SiₓB_{y}Z_{z}. M denotes one or more elements from the group of elements molybdenum (Mo), tantalum (Ta) or zirconium (Zr), T denotes one or more elements from the group of elements vanadium (V), manganese (Mn), chromium (Cr), cobalt (Co) or nickel (Ni) and Z one or more elements from the group of elements carbon (C), phosphorus (P) or germanium (Ge). The indices a, b, c, d, x, y, and z are given in atomic % and satisfy the following conditions:

0≤a<1.5,

0≤b<2,

0≤(b+c)<2,

0≤d<5,

10<x<18,

5<y<11 and

0≤z<2.

The alloy can contain up to 1 atomic % of impurities.

In some exemplary embodiments, the strip consists of a cobalt alloy, which is described by the formula Co_{100-a-b-c-d-z-y-z}FeₐCu_{b}M_{c}T_{d}SiₓB_{y}Z_{z}. M denotes one or more elements from the group of elements niobium (Nb), molybdenum (Mo) and tantalum (Ta), T denotes one or more elements from the group of elements manganese (Mn), vanadium (V), chromium (Cr) and nickel (Ni) and Z one or more elements from the group of elements carbon (C), phosphorus (P) and germanium (Ge). The indices a, b, c, d, x, y, and z are given in atomic % and satisfy the following conditions:

1.5<a<15,

a.<b<1.5,

≤c<5,

0≤d<5,

12<x<18

5<y<8,

0≤z<2.

The alloy can contain up to 1 atomic % of impurities, preferably up to 0.5 atomic % of impurities.

As mentioned, the strip may be heat treated, wherein the heat treatment is done under tensile stress, to achieve desired magnetic properties (“zina” material). In some exemplary embodiments, the soft magnetic strip has a nanocrystalline structure, in particular a nanocrystalline structure in which at least 50% by volume of the grains have an average size of less than 100 nm.

The soft magnetic strip may have a hysteresis loop with a central linear region, a remanence ratio, Jr/Js, of remanence (Jr) to saturation induction (Js) of less than 0.1, and a ratio Hc/Ha of coercivity (Hc) to anisotropy field strength (Ha) of less than 0.1. The permeability of the toroidal strip core can range from 40 to 10,000.

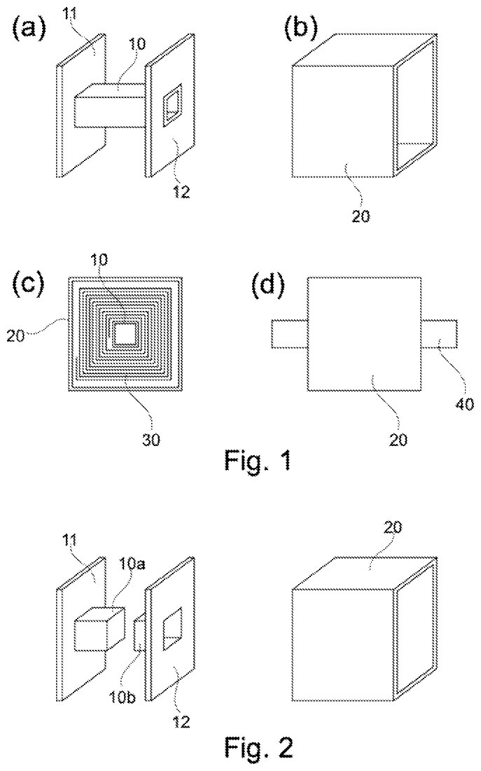

FIG. 1 illustrates an exemplary embodiment of a suitable carrier for producing a magnetic core with housing. Diagram (a) of FIG. 1 shows the carrier 10 which is substantially in the form of a hollow prism (generally a cylinder with any base) having side walls 11 and 12 at its ends. The inner hole runs through the prism along its longitudinal axis. In the example shown, the prism is a cuboid with an approximately square base. However, differently shaped bases are also possible. In the case of a circular shape, the carrier 10 has the shape of a circular cylinder. The side walls 11 and 12 and the central part (the hollow prism) are an integral component and can be made of plastic material, for example (such as by means of injection molding).

Diagram (b) of FIG. 1 illustrates an outer shell 20 that fits the carrier 10 from diagram (a). In the present example, this also has a cuboid shape and its inner dimensions are chosen so that they exactly match the outer dimensions of the side walls 11 and 12 of the carrier 10 so that the outer shell 20 can be slid or pushed over the carrier 20. When assembled, the parts 10 (with side walls 11 and 12) and 20 form a closed housing.

Before the housing part 20 is slid or pushed over the carrier 10, a soft magnetic strip is wound around the carrier 10 in order to produce a wound magnetic core 30. The length of the carrier 10 is dimensioned in such a way that the soft magnetic strip fits exactly between the two side walls 11 and 12. After the strip has been wound onto the core, the outer shell 20 can be slid or pushed over the wound carrier, as a result of which the wound core is surrounded on all sides by the housing. As mentioned above, the carrier 10 forms part of the housing. Diagram (c) of FIG. 1 shows a cross section through the magnetic core 30 including the housing (parts 10, 20), wherein the cutting plane is perpendicular to the longitudinal axis of the carrier 10. Diagram (d) of FIG. 1 shows a side view of the magnetic core arranged in the housing, with a conductor 40 being passed through the inner hole of the carrier 10.

FIG. 2 illustrates another example of a hollow prism or a hollow cylinder 10, albeit consisting of two parts 10a 10b and with a division along the longitudinal axis. The side wall 11 and the part 10a are an integral component. The same applies to the side wall 12 and the part 10b. The parts 10a and 10b can be identical and symmetrical with respect to the longitudinal axis of the carrier 10. Put together coaxially, the parts 10a and 10b form a carrier which looks essentially the same as the carrier in FIG. 1, diagram (a). The outer shell 20 of FIG. 2 is essentially the same as that of FIG. 1, diagram (b). In an exemplary embodiment, a core is wound only around part 10a and part 10b completes the carrier 10 in the axial direction. In this case, part 10b may be shorter than part 10a along the longitudinal axis. In another exemplary embodiment, a toroidal strip core is wound both around part 10a and around part 10b. The wound parts 10a, 10b are then joined together as shown in the left-hand part of FIG. 2 and then connected to part 20 to form a housing. In this case, there are two toroidal strip cores in the housing. This concept can also be extended to three or more cores.

In the example shown in FIG. 3, diagram (a), the carrier 10 has the shape of a hollow cylinder with an oval base. Unlike in the previous examples, the side walls 11 (not visible in FIG. 3 because they are covered) and 12 are not part of the carrier 10 but of the outer shell 20, which is divided into parts 20a and 20b along the longitudinal axis. The parts 20a and 20b can be the same, each having the shape of a half-shell, and when put together they form the outer shell 20. After the carrier 10 has been wound with the soft magnetic strip 30, the parts 20a and 20b can be slid or pushed over the core 30 arranged on the carrier 10, wherein the parts 20a and 20b together with the carrier 10, completely enclose the wound core 30. The contour of the openings in the side faces 11 and 12 is essentially congruent with the outer contour of the carrier 10, so that the parts 20a and 20b can be slid or pushed onto the end of the carrier 10 in order to close the housing. FIG. 3, diagram (b), shows a cross section through the core 30 including the housing. Also in this example, the carrier 10 can be divided into two or more parts, and a separate core can be wound around each part. The carriers are then joined together along the longitudinal axis, and after the housing has been completed, the cores are arranged (coaxially) next to one another in this housing.

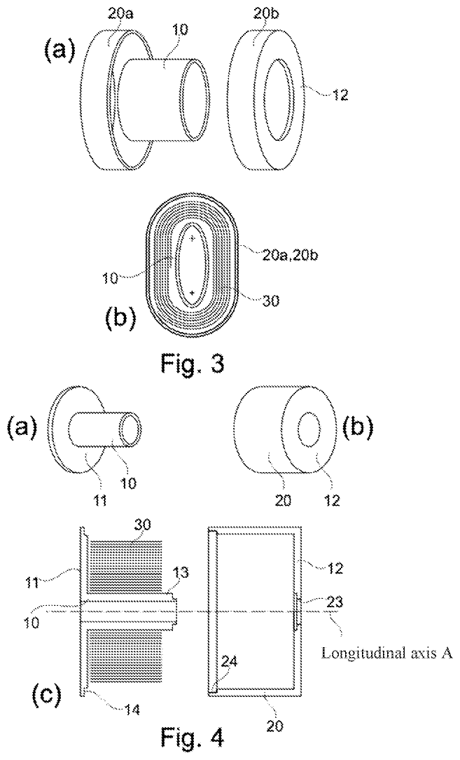

In the example shown in FIG. 4, the carrier 10 has the shape of a hollow cylinder with a circular base, with a side wall 11 being connected to the hollow cylinder. The opposite side wall 12 is connected to the outer shell 20 (see FIG. 4, diagram (b)). FIG. 4, diagram (c), shows the assembly of the housing by means of a longitudinal sectional representation. In the example shown, the outer shell 20 (with side wall 12) is slid or pushed from right to left over the core 30 wound around the carrier 10. The right-hand end of the carrier 10 is slid or pushed into the corresponding opening in the side wall 12, the end of the carrier 10 and the contour of the opening in the side wall 12 being shaped in such a way that the carrier 10 can snap into the opening in the side wall 12. This means that the two parts are attached to one another using a snap-in connection. The same applies with regard to the outer contour of the side wall 11 and the corresponding end of the outer shell 20, which are also designed in such a way that the side wall 11 snaps into place at the end of the outer shell. In this way, the outer shell and the carrier can be held together with the aid of the side walls 11 and 12 in a form-fitting manner. At the same time, the housing around the core 30 is closed. In other examples, the housing parts can also be glued or welded (such as by means of ultrasonic welding).

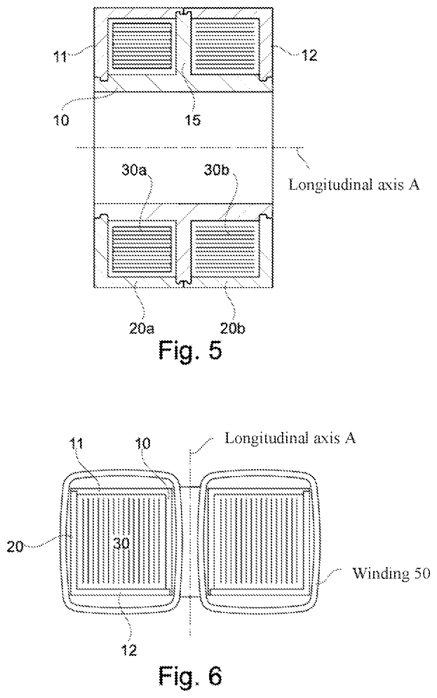

The example of FIG. 5 can be considered as a modification of the example of FIG. 3. In the example shown, the outer shell 20 is formed from two parts 20a, 20b, with the side wall 11 being connected to the part 20a and the side wall 12 being connected to the part 20b. Side wall and outer shell can each form an integral component. The side walls 11 and 12 each have an opening which can be slid or pushed over one end of the cylindrical carrier 10.

In contrast to the example from FIG. 3, the carrier 10 from FIG. 5 has a circumferential web 15 in the middle, the outer contour of which can be designed in such a way that the inner contour of the outer shell parts 20a, 20b can snap onto the web 15 (snap-in connection). In this case, two coaxially arranged cores 30a, 30b can be wound on the carrier 10, one core to the left of the web 15 and another core to the right of the web 15. The two cores 30a and 30b can be made of the same material or of different materials with different magnetic properties. The contour of the cross-sectional area of the carrier 10 cannot be seen in FIG. 5. It is understood that the cross-sectional area of the carrier 10 can have any shape, such as a circular shape as in the example of FIG. 4, or a square shape as in the example of FIG. 1.

FIG. 6 illustrates an example of an inductive component with a magnetic core 30 including a housing according to FIG. 4 and a coil wound around the core 30, for example a choke. The coil can be made of insulated copper wire. In another example, two or more coils can be wound around the core, for example to create a transformer or current converter.

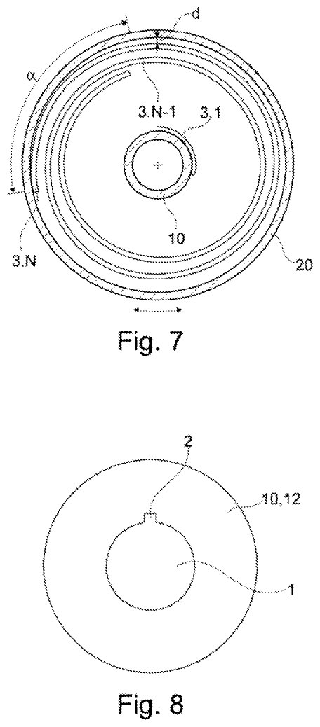

FIG. 7 shows a cross-sectional view (section plane normal to longitudinal axis A), such as a cross-section through the core shown in FIG. 4. The strip wound up to form the magnetic core is only shown schematically. The innermost layer (winding) is denoted by 3.1, the penultimate layer (winding) is denoted by 3.N−1 and the outermost, last layer by 3.N. The strip layers of the core are not completely shown in FIG. 7. It is desirable that the distance d (clearance) between the outermost layer 3.N and the inside of the outer shell 20 is as small as possible. If the outermost layer 3.N of the strip is not attached to the underlying layer 3.N−1 (e.g. by means of an adhesive strip or spot welding), the last layer protrudes (due to the spring effect of the strip) in an angular region a, whereby the angular region a is the smaller, the smaller the distance d is.

FIG. 7 shows a section of a core in which the outer layers of the strip have not been fixed, namely in which there is a slight coming off of the helical winding of the core. The distance d between the outermost strip layer of the core and the inner wall of the housing must be as small as possible so that the region in which there is an air gap between the strip layers of the core (angle α) does not become too large. In practice, it is possible to make the clearance d so small that the last strip layer 3.N does not have to be fastened and the protruding of the strip end in the angular region a does not significantly affect the magnetic properties of the core. This means that the effective permeability and thus the inductance of the toroidal strip core does not change significantly when the strip end protrudes in the angular region a. In particular, the inductance of the toroidal strip core is reduced by no more than 10% due to the protruding of the strip end in the angular region a. It will be appreciated that the inductance typically characterizes a coil wound around the core, wherein the inductance is dependent on the number of windings of the coil. However, an inductance can also be defined for a magnetic core if the number of windings N is set to a standard value such as N=1.

FIG. 8 shows a circular-cylindrical carrier 10 (with side wall 12) in a side view. The carrier 10 can be designed essentially like the carrier of FIG. 1, diagram (a), with the difference that the central part of the carrier 10 (without the side walls 11, 12) has a circular cross-section (instead of a square cross-section). The carrier 10 is fitted onto a shaft 1 for winding a soft magnetic strip 30 to produce a core. In order to ensure an easily detachable, form-fitting connection between the shaft 1 and the carrier 10, the shaft 1 can have a projection 2 which is inserted into a corresponding groove in the inner hole of the carrier when the carrier 10 is fitted on the shaft 1. Other form-fitting connections (such as a keyway) are also possible.

Some of the exemplary embodiments described here are summarized in the following. This is not an exhaustive list of technical features, but merely an exemplary summary.

One exemplary embodiment relates to a method for producing a toroidal strip core. The method comprises fitting a carrier on a shaft (cf. FIG. 8), the carrier having a through opening along a longitudinal axis, into which opening the shaft can be inserted. The method further comprises winding (at least) one soft magnetic strip around the carrier into (at least) one toroidal strip core by rotating the shaft. After the winding process, the carrier is removed from the shaft. In some exemplary embodiments, the method further includes enclosing the toroidal strip core in a housing by sliding or pushing at least one housing part (see, for example, FIGS. 1, 2 and 4, outer shell 20, and FIGS. 3 and 5, housing parts 20a, 20b) over the toroidal strip core and connecting it to the carrier, the carrier itself forming part of the housing.

In the examples described, that part of the carrier around which the soft magnetic strip is wound has the shape of a hollow cylinder. The hollow cylinder can have a circular (see FIG. 4), oval (see FIG. 3) or rectangular (see FIG. 1) cross-section. Cylinders with a rectangular or square cross-section are also known as prisms. The carrier can consist of an insulator (such as a plastic material) or a non-magnetic metal.

The carrier on which the toroidal strip core is located and/or of the at least one housing part (such as the outer shell 20, cf. FIG. 4), which is slid or pushed over the toroidal strip core, has at least one side wall which is essentially at right angles to a longitudinal axis of the carrier. The side walls allow a closed housing for the toroidal strip core. In the example shown in FIG. 1 both side walls are arranged on the carrier, in the example shown in FIG. 4 one side wall is part of the carrier and the other side wall is part of the outer shell. In the example shown in FIG. 3, both side walls are parts of the (two-part) outer shell. The individual housing parts (carrier and outer shell) can be fitted to one another in a form-fitting manner, for example by means of snap-in connections (locking connections) in order to form a closed housing. Gluing or ultrasonic welding can be considered as an alternative to the form-fitting connection for connecting the housing parts.

In one embodiment, the beginning of the soft magnetic strip is fixed on the carrier before winding, for example by means of adhesive or adhesive strip. Fixing the strip end to the underlying strip layer is not absolutely necessary. The end of the strip, which can protrude due to the spring action of the strip, is held by the inside of the housing and secures the toroidal strip core before unwinding. The clearance between the housing and the toroidal strip core must be dimensioned to be correspondingly small.

A further exemplary embodiment relates to a device with a carrier which has a through opening along a longitudinal axis, and at least one soft magnetic strip wound around the carrier to form a toroidal strip core. The strip is wound directly onto the carrier so that there is no play between the toroidal strip core and the carrier. The device can have at least one housing part, which surrounds the toroidal strip core and is connected to the carrier in such a way that the at least one housing part forms a closed housing around the toroidal strip core together with the carrier. In one exemplary embodiment, the soft magnetic strip was heat-treated before winding, wherein the desired magnetic properties are adjusted during the heat treatment by applying a tensile stress.

The technical features of the individual exemplary embodiments described here can be combined to form further exemplary embodiments, provided they are not mutually exclusive alternatives.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The expression “and/or” should be interpreted to include all possible conjunctive and disjunctive combinations, unless expressly noted otherwise. For example, the expression “A and/or B” should be interpreted to mean only A, only B, or both A and B. The expression “at least one of” should be interpreted in the same manner as “and/or”, unless expressly noted otherwise. For example, the expression “at least one of A and B” should be interpreted to mean only A, only B, or both A and B.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method, comprising:
fitting a carrier, which has a through opening along a longitudinal axis, or a part of the carrier, onto a shaft;
winding at least one soft magnetic strip around the carrier to form at least one toroidal strip core, by rotating the shaft; and
removing the carrier together with the at least one toroidal strip core from the shaft.

2. The method of claim 1, further comprising:
enclosing the at least one toroidal strip core in a housing by sliding at least one housing part over the at least one toroidal strip core and connecting the at least one housing part to the carrier, wherein the carrier itself forms a further housing part.

3. The method of claim 2, wherein the carrier and/or the at least one housing part has at least one side wall which is essentially at right angles to a longitudinal axis of the carrier.

4. The method of claim 2, wherein the at least one housing part and the carrier are mounted on one another by snap-in connections.

5. The method of claim 2, wherein the at least one housing part and the carrier are mounted on one another by gluing or ultrasound welding.

6. The method of claim 1, wherein a part of the carrier around which the at least one soft magnetic strip is wound has a shape of a hollow cylinder.

7. The method of claim 1, wherein an outer end of the wound strip is not attached to an underlying layer of the strip but is held by an inner side of the at least one housing part, such that the at least one toroidal strip core is prevented from unwinding the at least one soft magnetic strip.

8. The method of claim 7, wherein a clearance between the at least one toroidal strip core and the inner side of the at least one housing part is such that an effective permeability and an inductance of the at least one toroidal strip core is reduced by the protruding end of the wound strip by no more than 10%.

9. The method of claim 1, wherein the carrier consists of a non-magnetic, electrically non-conductive material.

10. The method of claim 1, wherein the carrier consists of a non-magnetic metal.

11. The method of claim 1, wherein a beginning of the at least one soft magnetic strip is fixed on the carrier before winding.

12. The method of claim 1, wherein the through opening of the carrier and the shaft are formed such that the carrier is held in a form-fitting manner on the shaft.

13. The method of claim 1, wherein the at least one soft magnetic strip is made of an alloy that comprises Fe_{100-a-b-c-d-x-y-z}CuₐNb_{b}M_{c}T_{d}SiₓB_{y}Z_{z}, wherein M is one or more of the elements Mo, Ta, or Zr,
T is one or more of the elements V, Mn, Cr, Co, or Ni, and Z is one or more of the elements C, P, or Ge, wherein a, b, c, d, x, y, z are given in atomic % and a, b, c, d, x, y, z satisfy the following conditions:
0≤a<1.5;
0≤b<2;
0≤(b+c)<2;
0≤d<5;
10<x<18;
5<y<11;and
0≤z<2,
and wherein the alloy contains up to 1 atomic % of impurities.

14. The method of claim 1, wherein the at least one soft magnetic strip is made of an alloy that comprises Co_{100-a-b-c-d-x-y-z}FeₐCu_{b}M_{c}T_{d}SiₓB_{y}Z_{z}, wherein M is one or more of the elements N_{b}, Mo, and Ta, T is one or more of the elements Mn, V, Cr, and Ni, and Z is one or more of the elements C, P, or Ge, wherein a, b, c, d, x, y, and z are given in atomic % and a, b, c, d, x, y, and z satisfy the following conditions:
1.5<a<15;
0.1<b<1.5;
1≤c<5;
0≤d<5;
12<x<18;
5<y<8;and
0≤z<2,
and wherein the alloy contains up to 1 atomic % of impurities.

15. The method of claim 1, wherein the at least one soft magnetic strip has a nanocrystalline structure in which at least 50% by volume of the grains have an average size of less than 100 nm.

16. The method of claim 1, wherein the at least one soft magnetic strip has a hysteresis loop with a central linear region, a remanence ratio, Jr/Js<0.1, and a ratio H_{c}/Hₐ of coercivity H_{c} to anisotropy field strength Hₐ of less than 0.1.

17. The method of claim 1, wherein the at least one soft magnetic strip has been heat treated under tensile stress.

18. A method, comprising:
fitting a first part of a carrier, which has a through opening along a longitudinal axis, onto a shaft;
winding at least one soft magnetic strip around the first part of the carrier to form a first toroidal strip core, by rotating the shaft;
removing the first part of the carrier together with the first toroidal strip core from the shaft;
fitting a second part of the carrier;
winding a second soft magnetic strip around the second part of the carrier to form a second toroidal strip core, by rotating the shaft;
removing the second part of the carrier together with the second toroidal strip core from the shaft; and
assembling the first part and the second part of the carrier together with the first and second toroidal strip cores wound thereon, wherein the first part and the second part of the carrier are coaxial with one another.

19. The method of claim 18, further comprising:
enclosing the first and second toroidal strip cores in a housing by sliding at least one housing part over the first and second toroidal strip cores and connecting the at least one housing part to the first part and the second part of the carrier, wherein the carrier itself forms a further housing part.

20. A device, comprising:
a carrier having a through opening along a longitudinal axis; and
at least one soft magnetic strip wound around the carrier to form a toroidal strip core,
wherein the at least one soft magnetic strip is wound directly onto the carrier so that there is no play between the toroidal strip core and the carrier.

21. The device of claim 20, further comprising:
at least one housing part, which surrounds the toroidal strip core and is connected to the carrier in such a way that the at least one housing part together with the carrier forms a closed housing around the toroidal strip core.
